(19) United States
(12) Patent Application Publication
(10) Pub. No.: US 2011/0087711 A1
(43) Pub. Date: Apr. 14, 2011

(54) System for Entry, Storage, and Manipulation of Information and Data Related To Land Rights Acquisition Projects

(76) Inventor: William C. Justice, Youngsville, LA (US)

(21) Appl. No.: 12/904,581

(22) Filed: Oct. 14, 2010

Related U.S. Application Data
(60) Provisional application No. 61/251,323, filed on Oct. 14, 2009.

(51) Int. Cl. G06F 17/30

(52) U.S. Cl. 707/804; 707/E17.045

(57) ABSTRACT

A computer-implemented method and system for processing of data related to land rights acquisition projects, commonly encountered in connection with oil and gas drilling and production. The system and method use a computer based database tool known as “cross tables,” which create an association between unique identification (“ID”) numbers assigned to each of the database entries Accordingly, the system and method of the present invention may include the steps of acquiring data regarding tracts, owners, and contracts; entering same into a digital processor-based database; creating tables of tracts, owners, and contracts, and data related to each, wherein each of the tracts, owners, and contracts are assigned unique identification numbers; creating tables establishing a relationship or link between the unique identification numbers; and creating desired reports by accessing certain of the data and arranging same in a user-friendly format.

### CROSS REFERENCE TO RELATED APPLICATIONS

This regular United States patent application claims priority to U.S. Provisional patent application Ser. No. 61/251,323, filed Oct. 14, 2009, for all purposes, and said provisional patent application is hereby incorporated by reference in its entirety.

### BACKGROUND

Various computer-implemented systems and methods are used for the entry, storage, and manipulation of information and data for various purposes, the system generally including a database maintained on a digital processor. Frequently, such systems are used for the entry, storage, and manipulation of data related to land rights acquisition projects. Such projects frequently take the form of acquiring oil, gas and mineral leases in connection with the drilling of oil and gas wells, over a desired area of land; seismic permitting projects, wherein seismic permits are acquired from landowners to allow seismic operations on the land; and right-of-way projects, frequently in connection with the installation of pipelines, where easements or rights of way must be acquired from the landowners to install the pipeline on or across their land. It is to be understood that the term “land rights acquisition project” is to be given its broadest possible meaning, and includes not only initial acquisition of such rights, but continued maintenance and management thereafter. Many of such projects fall within the realm of work known as “petroleum land management,” and involves petroleum landmen/women.

It is to be understood that the above-described land rights acquisition projects are illustrative and not exclusive.

Land rights acquisition projects can cover large areas of land, containing many different “tracts” or legal subdivisions of land, and many different owners not only of separate tracts, but within each tract. Each tract may be affected by one or more legal agreements (sometimes called “instruments), such as oil, gas and mineral leases; right of way agreements; surface use agreements, etc., all referred to herein as “contracts.” In short, such projects may involve a tremendous quantity of data related to the land (“tracts”), owners thereof (“parties”), and agreements affecting both the tracts and the parties (“contracts”).

Since the development of digital processors, it has become common for the tract, contract and party data to be entered into a database on the digital processor, or computer. Known prior art databases in this area of application are of the structure known as “hierarchical.” Hierarchical databases are generally oriented toward one of the three primary data types described above, and in practice are usually either “tract oriented” or “contract oriented.” The “orientation” defines the variable which may be considered as the “dominant” variable, with the other variables subordinate thereto.

A typical tract oriented system, as in the known prior art hierarchical systems, may be broadly described as follows. The dominant variable, in this case tracts, are listed in a table. Each tract is assigned a tract identification or TractID number. In addition to a brief description of the tract, more detailed data regarding its legal description, size, etc. can be entered. An exemplary tract table follows:

| TractID | Tract | Other Tract Info |
|---|---|---|
| 1 | Pasture | Legal description, size, etc. |
| 2 | Marsh | Legal description, size, etc. |
| 3 | Woodlands | Legal description, size, etc. |

Data regarding the contracts related to and affecting the various tracts (which are listed in the lefthand column by their unique identifier, or TractID), is entered in a “sub table,” as follows:

| TractID | Contract | Other contract info |
|---|---|---|
| 1 | OGM lease 1 | Term, bonus, royalty, etc. |
| 1 | Surface use 1 | Term, annual payment |
| 2 | OGM lease 1 | Term, bonus, royalty, etc. |
| 2 | Surface use 1 | Term, annual payment |
| 2 | Right of way 1 | Term, area covered, payment, etc. |
| 3 | OGM lease 2 | Term, bonus, royalty, etc. |
| 3 | Surface use 1 | Term, annual payment |

The foregoing sub table illustrates how the Tract remains as the dominant variable, with the Contract data entered and associated with a given Tract. As can be seen in this example, data regarding the tracts (the dominant variable) is entered only one time. However, data regarding the contracts (a subordinate variable) must be entered into the database subtable multiple times.

It is understood that a system could be similarly oriented with “contracts” as the dominant variable, in which case “tracts” would become the subordinate variable.

This prior art system, namely a hierarchical database arrangement, has several limitations, including but not limited to:
1) Multiple entry of subtable data: data entry requires personnel with the attendant costs, and multiple entries give rise to the possibility of a greater number of errors in the data entry process. The requirement of multiple entry of subordinate variable data is seen in the foregoing subtable, where “OGM lease 1” must be entered twice, since it affects the tracts assigned TractID 1 and TractID 2. In real-life projects, data regarding a contract may need to be entered tens, if not hundreds, of times.
2) Revision and editing of sub-table data: in the example above, should data related to a particular contract need to be changed (due to an error in entry, change in substantive provisions, etc.), then each and every record of that contract must be accessed and changed, thereby multiple revision efforts are required. Similar to the note above, the requirement to access a given contract (i.e., subordinate variable) multiple times is seen in the foregoing subtable, where “OGM lease 1” must be accessed and revised twice, since that contract affects the tracts assigned TractID 1 and TractID 2.

### SUMMARY

Hierarchical database systems currently in use for land ownership projects have various disadvantages. The present invention uses a computer-based database tool known as “cross tables,” which are known in connection with use in other database applications, however, to Applicant's knowledge, not in connection with database systems for land rights acquisition projects. Accordingly, the system and method of the present invention comprises the steps of acquiring data regarding tracts, owners, and contracts; entering same into a digital processor-based database; creating tables of tracts, owners, and contracts, and data related to each, wherein each of the tracts, owners, and contracts are assigned unique identification numbers; creating tables establishing a relationship or link between the unique identification numbers; and creating desired reports by accessing certain of the data and arranging same in a user-friendly format.

### BRIEF DESCRIPTION OF THE DRAWINGS

FIG. 1 is a schematic diagram of computer equipment and files which may be used to implement a preferred embodiment of the present invention.

FIG. 2 is a flow diagram depicting some of the steps that may be performed when implementing a preferred embodiment of the present invention.

FIGS. 3A-3C are exemplary data and cross tables, as used in the present invention.

FIG. 4 is an exemplary input/output data screen, oriented toward “Tracts,” of the system of the present invention.

FIG. 5 is an exemplary input/output data screen, oriented toward “Contracts,” of the system of the present invention.

FIG. 6 is an exemplary input/output data screen, oriented toward “Party” (or “Contract Party”) of the system of the present invention.

FIG. 7 is another schematic diagram of computer equipment which may be used to implement a preferred embodiment of the present invention.

FIG. 8 is a flow diagram depicting some of the steps that may be performed when implementing another aspect of a preferred embodiment of the present invention, related to compilation of an abstract of title to a tract or tracts of land.

### DETAILED DESCRIPTION OF SOME OF THE PRESENTLY PREFERRED EMBODIMENTS

While various embodiments of the system are possible and contemplated within the scope of this invention, some of the presently preferred embodiments can be described in conjunction with the drawings.

The present invention, among other attributes, uses a different table structure to minimize or eliminate certain of the drawbacks related to the prior art systems, particularly in connection with land rights acquisition projects. The present invention comprises a database, preferably maintained on a digital processor, which has a table structure referred to as a “cross table structure,” employing “cross tables,” as contrasted with the hierarchical structure of the known prior art systems as described above. The present system and method further employs a series of interactive computer screens (and other associated hardware) to enable the user to enter, organize, revise, extract and otherwise manipulate data in the database. A computer program or programs implements the system and method. As mentioned above, the system has particular, although not exclusive, application in connection with land rights acquisition projects.

### Data (Information) Gathering

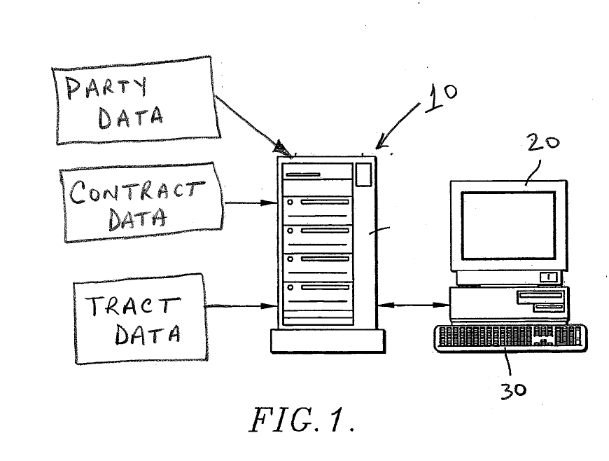

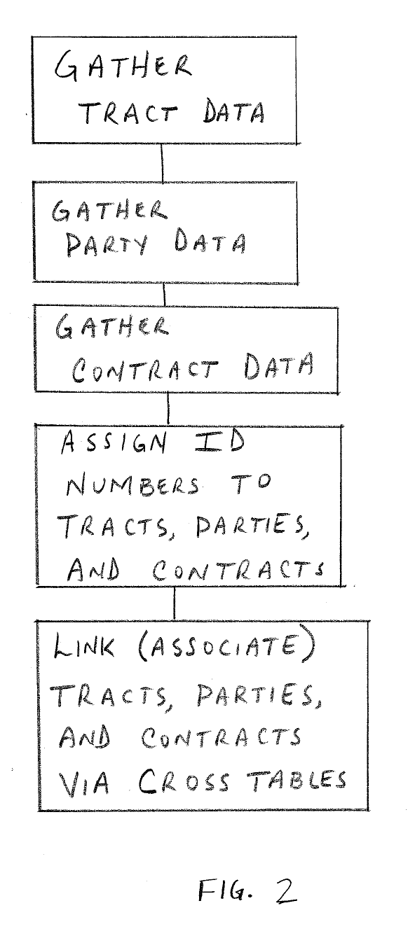

Typically, initial steps of the method of the present invention comprise the gathering of relevant data. As seen in FIG. 2, information or data regarding tracts, parties, and contracts is gathered. As illustrated in FIG. 1, these data are entered into a digital processor, namely a computer 10, which preferably comprises a conventional monitor 20, a keyboard 30 or other input device, and at least one CPU 40. It is understood that data can be entered and stored in the computer by manual entry via keyboard 30, scanning of images, downloading in digital format, etc.

In connection with land rights acquisition projects, typical data which are gathered and entered into the database include:
tract data, including size (e.g. in acres), metes and bounds calls for boundaries
party data, including names of owners of given tracts or those holding other rights in and to tracts
contract data, including the terms and conditions of contracts affecting a given tract (e.g., oil, gas and mineral leases; surface use agreements; pipeline rights of way). Note that the listing in FIG. 2 is not intended to imply or require any particular sequence or order of gathering or entry of data; it is to be understood that the data can be gathered and entered in any desired sequence, independently of categories.

### Creating Tables of Data, Cross Tables

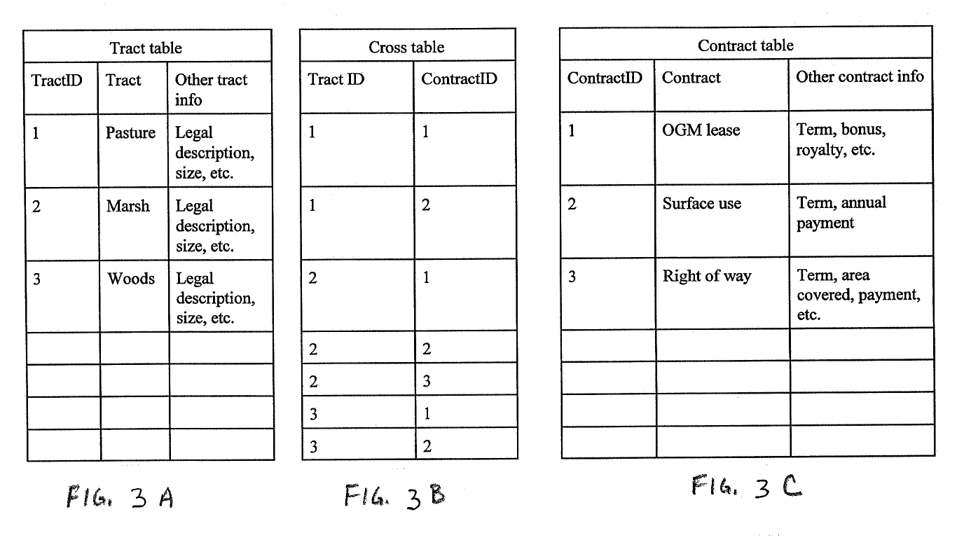

Once data regarding the various categories (e.g., tracts, parties, and contracts) are entered, tables are created for each category of data. FIGS. 3A-3C illustrate tables of “Tracts” and “Contracts.” Unlike prior art systems, the present invention does not have a hierarchy of data (in tables and sub-tables), instead each category of data (Tracts and Contracts, in the illustration; however, it is understood that a greater number of variables is contemplated, such as a third variable of Party, and additional variables are possible) is held at an equal level, and a cross table is used to associate one data item or “record” (for example, a tract) with another record (for example, a contract). While the illustrated types of data are “tracts” and “contracts,” it is understood that a table is preferably created for each category.

FIG. 3A is a table of Tracts, with each Tract being assigned an identification number or TractID. FIG. 3C is a table of Contracts, with each contract being assigned an identification number or ContractID. In similar fashion, each record or entry in each table is preferably assigned a unique identification (“ID”) number.

Another step of the method of the present invention is to create cross tables, which as previously described are tables which associate or link records or data in data tables to each other. FIG. 3B shows a cross-table, which contain TractID and ContractID numbers (following creation of the tract and contract data tables); it is understood that the cross-tables may contain other and additional data. Note that the relationships between tracts and contracts which were set out in the hierarchical tables above are preserved in the cross table arrangement in FIGS. 3A-3C. By the relationship established in the cross table, a given tract and a given contract are linked or associated with one another. Note that the cross table need contain only sufficient data to create an association between records in other tables, however, if desired, the cross table may contain additional data.

It is further to be understood that it is not required that an association be established between all records. For example, with the present invention, a contract may be entered into the system, yet that contract may have no association with any tract or party. This is a benefit over hierarchical systems, wherein in order to enter a subordinate record (e.g., a contract record in a tract-oriented system) it is required that an association between that contract and a tract be created.

Various other benefits arise from use of the cross table arrangement of the present invention. Data regarding a particular record, for example a contract, need be entered only one time, as opposed to entry multiple times (once for each tract with which it is associated) in a hierarchical system. Further, should a revision need to be made to initially entered data, for example in a contract, then the revision need be made only a single time in the record for the contract at issue.

### Accessing Data; Creating Desired Reports

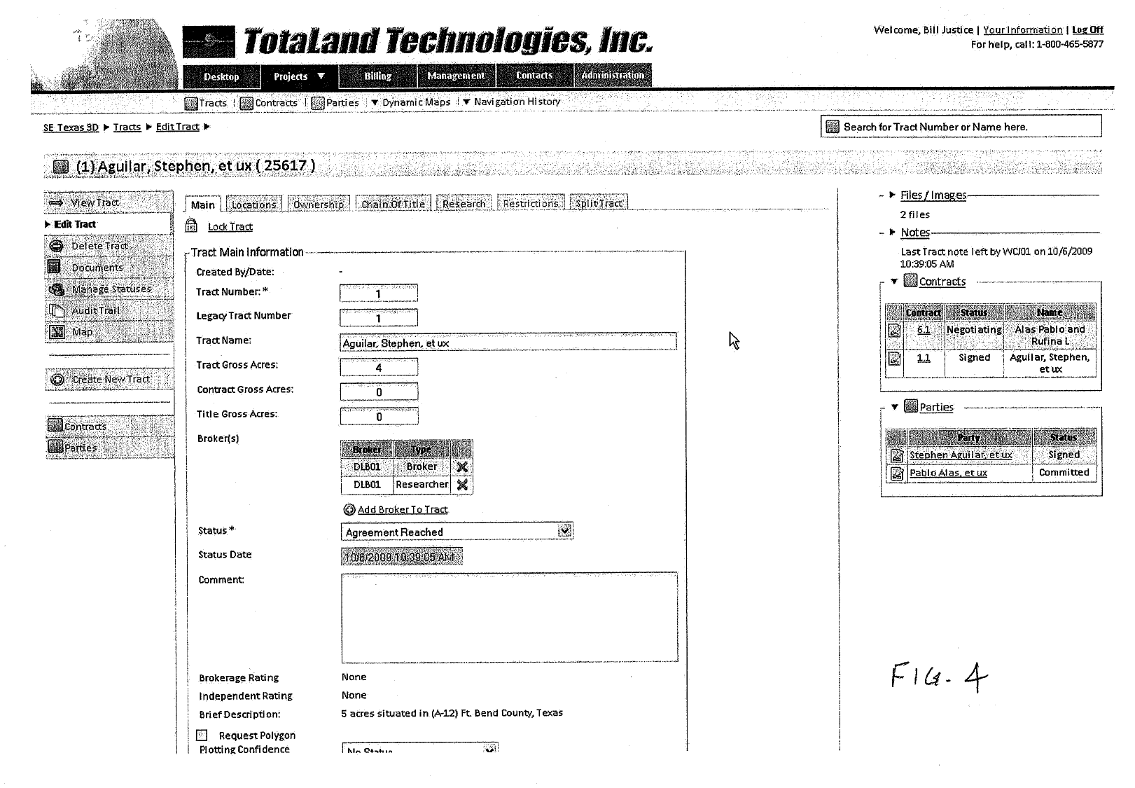

The present system uses one or more microprocessors and related hardware (monitor, keyboard, “mouse” or similar input device, etc.), along with computer programming, to utilize the data table and cross table system set out above, to yield an interactive system which is easily and efficiently used. FIGS. 4-6 are input screens of one commercially available embodiment, which illustrates certain of the attributes of the system. FIG. 4 shows an exemplary input/output screen wherein the viewpoint is oriented toward “Tracts.” A particular tract—in FIG. 4, Tract Number 1—is shown. Various tract data is displayed. On the right hand side of the screen, the Contracts which have been associated with Tract Number 1 (namely, the contracts which affect Tract 1) are listed (Contracts 6.1 and 1.1); along with the Parties which have been associated with Tract 1 (namely, those parties which hold an interest in Tract 1) are listed (Stephen Aguilar, et ux and Pablo Alas, et ux).

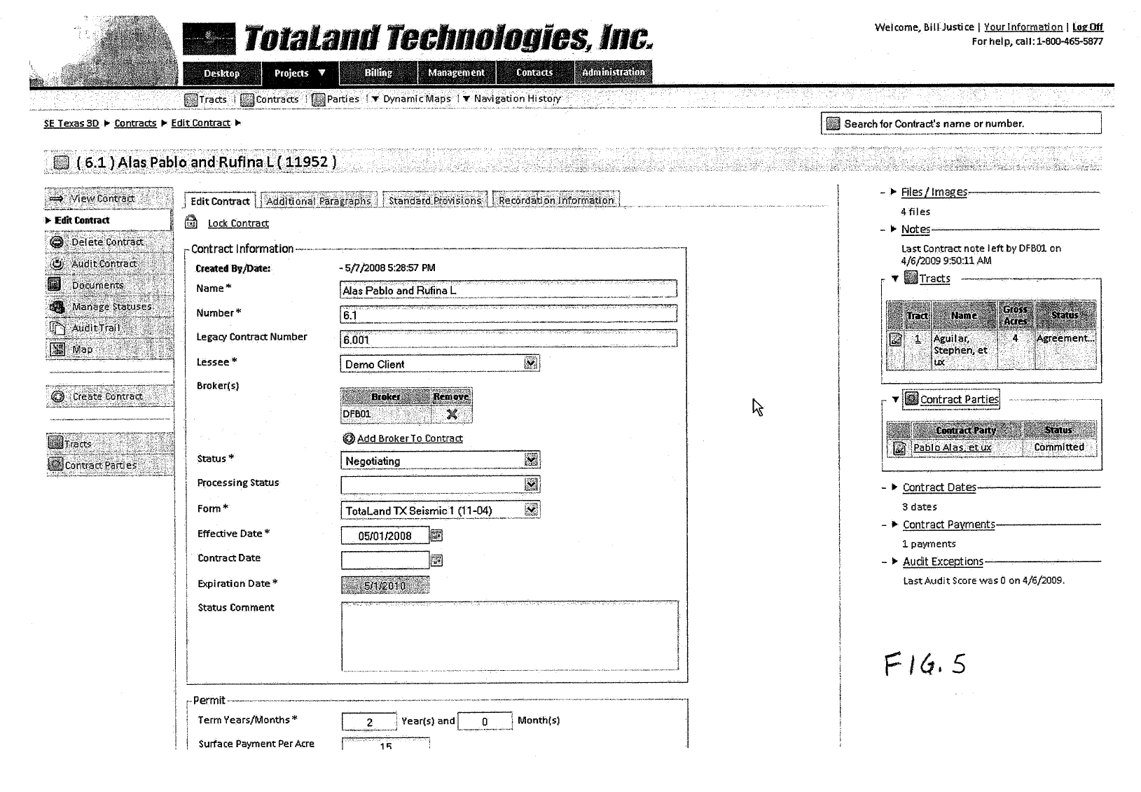

FIG. 5 shows an exemplary input/output screen wherein the viewpoint is oriented toward “Contract.” As can be seen, the Contract has been assigned number 6.1. Data about the contract is listed. On the right hand side of the screen, the Tracts which have been associated with Contract Number 6.1 are listed (Tract 1), as is the Party which has been associated with Contract Number 6.1 (Pablo Alas, et ux). Note that Contract 6.1 was displayed on FIG. 4 (Tract page) as a contract associated with Tract 1; likewise, on FIG. 5, Tract 1 is displayed as a tract associated with Contract 6.1. This illustrates the linked or associated aspect of the database entries. It is to be noted also that navigation between the linked-together or associated data records requires only that the user click the hyperlink(s) on the given record(s).

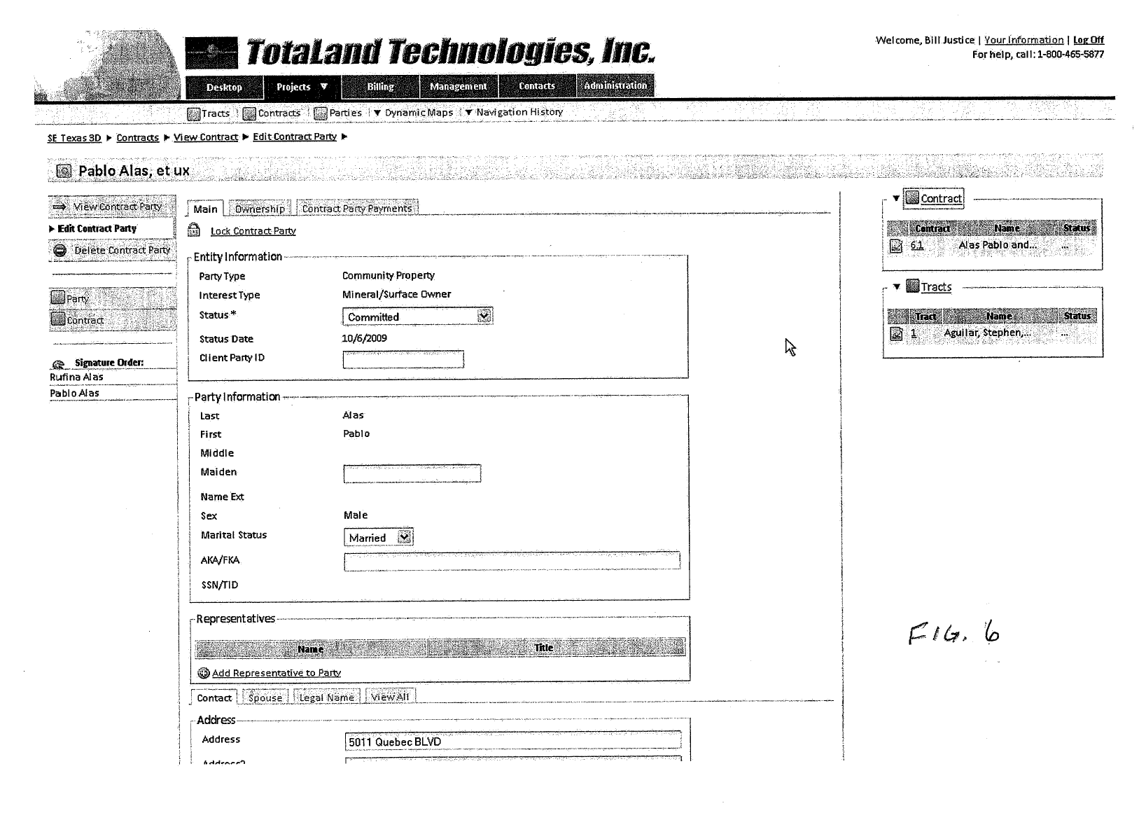

FIG. 6 shows an exemplary input/output screen wherein the viewpoint is oriented toward

“Party” (or “Contract Party”). As can be seen, the Contract Party is Pablo Alas. Data about this contract party is listed. On the right hand side of the screen, the Tract (Tract 1) which has been associated with Alas is listed; along with the Contract (Contract 6.1) which has been associated with Alas. It can be noted that these same associations are displayed on FIGS. 4 (Tract) and 5 (Contract).

It is understood that the present system comprises the creation of various reports or presentations of data, in formats as desired for particular purposes. It can be readily understood that the cross-table feature facilitates assembly of the data in a desired format. Further, if changes need to be made to a record (e.g., terms in a given contract must be revised), such changes need be entered only one time, as opposed to the multiple entries in a hierarchical system.

The computer program or programs of the present invention are stored in or on computer-readable medium residing on or accessible by the main computer 10 for instructing the computer 10 to perform certain steps of the present invention as described herein. The computer programs preferably comprise an ordered listing of executable instructions for implementing logical functions in the computer 10. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any means that can contain, store, communicate, propagate or transport the program for use by or in connection with the instruction execution system, apparatus, or device. The computer-readable medium can be, for example, but not limited to, an electronic, magnetic, optical, electromagnetic, infrared, or semi-conductor system, apparatus, device, or propagation medium. More specific, although not inclusive, examples of the computer-readable medium could include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM). The computer-readable medium could even be paper or another suitable medium upon which the program is printed, as the program can be electronically captured, via for instance, optical scanning of the paper or other medium, then compiled, interpreted, or otherwise processed in a suitable manner, if necessary, and then stored in a computer memory.

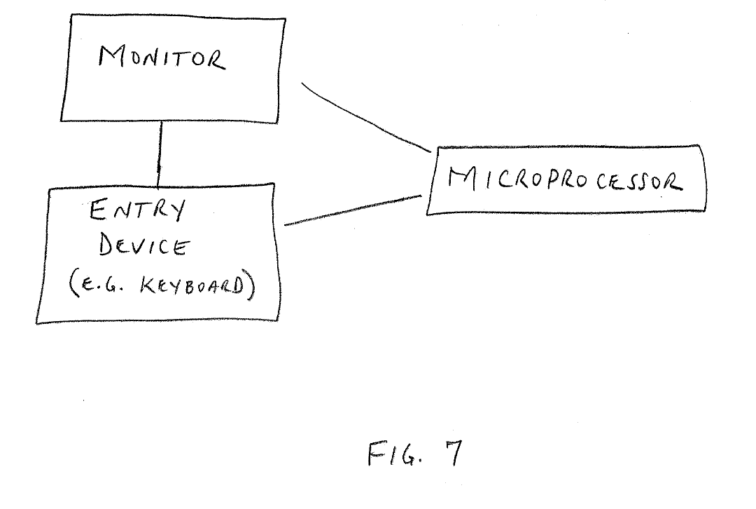

FIG. 7 is a simple schematic showing the relationship between different parts of certain of the hardware associated with the present invention. Other hardware may be used as appropriate.

### Creation of Tract “Abstracts of Title”

One task which is quite common in connection with land rights acquisition projects, particularly (but not exclusively) in connection with the leasing of tracts of land for the drilling and production of oil and gas, is the assembling or creation of what are commonly referred to as “abstracts of title.” These abstracts, fundamentally, comprise a collection of the contracts (i.e. legal instruments) which affect the title to a tract of land. Typically, an attorney will render a so-called “title opinion,” which opines as to the owner or owners of a tract of land; it is the owners (or other rights holders) from whom oil, gas and mineral leases are procured, and to whom various payments are made.

Traditionally, abstracts of title were assembled manually, by making paper copies of all relevant contracts, assembling same (usually in chronologic order) and frequently binding them together. Often, various title pages are inserted. In addition, a page or pages in the nature of cover sheets may be made for each contract, which has various summary type data about the contract. Such cover pages are referred to at times as “half sheets.” Usually, the entirety of the abstract document is sequentially page numbered for reference purposes.

The assembly of abstracts can be a very time consuming task. This is particularly true when documents must be inserted into the abstract between already present contracts; same requires a re-numbering of the abstract, etc.

The present invention greatly facilitates the assembly of abstracts, including pagination, revisions (adding or deleting contracts), etc. Preferably, as a starting point, all relevant contracts are stored on computer 10 in pdf (or other image) format, which (as described above) are linked (via cross tables) to other records, usually “tract” and “party.” The programming of the present invention then permits identification and selection of desired contracts, and sequential assembly of same, into an abstract. As implemented, the present system also permits the addition of contracts and instruments to the abstract, to flesh out the abstract for title examination purposes. Such additional instruments are listed and the user has the option to select which ones are to be included in the abstract. The present invention presents the option to create/include “half sheets” related to each contract, which are sheets with summary type information about the contract; often included as spacer sheets or cover sheets between the contracts and instruments in an abstract.

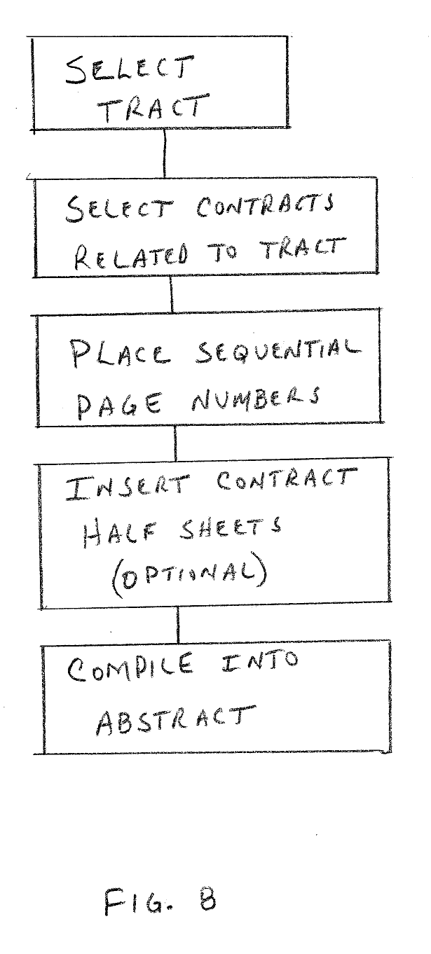

An exemplary sequence for preparation of an abstract is shown in FIG. 8. The tract or tracts which the abstract is to cover are selected (i.e. the tables are oriented to said tract(s)). Next, from a list of contracts affecting those tracts, a selection of contracts is made. The computer program or programs then sequentially page numbers the collection of contracts. If desired, contract half sheets are inserted covering the contracts (and pagination adjusted accordingly). Finally, the contracts are compiled into an abstract, which can be printed and bound if desired, or presented in another desired format. It is understood that the present invention comprises the computer program or programs required to implement the steps of the described method(s).

### CONCLUSION

While the preceding description contains many specificities, it is to be understood that same are presented only to describe some of the presently preferred embodiments of the invention, and not by way of limitation. Changes can be made to various aspects of the invention, without departing from the scope thereof.

Therefore, the scope of the invention is not to be limited to the illustrative examples set forth above, but encompasses modifications which may become apparent to those of ordinary skill in the relevant art, and is limited only by the scope of the appended claims and their legal equivalents.

I claim:

1. A computer-implemented method for entering, storing, and manipulating data related to land rights acquisition, comprising the steps of:
a) gathering and entering data into an electronic database in table format, said data comprising the categories of:
identity of tracts of land
owners of said tracts of land
contracts and other legal instruments related to said tracts of land,
each of said categories of data being stored in a table in said database, each of said tables comprising one or more entries corresponding to said tracts, owners, and contracts, each of said entries being assigned an identification (ID) number;
b) creating an association between at least some of the entries in separate tables, whereby said data may be grouped by any of the variables.

2. The method of claim 1, wherein said step of creating an association between at least some of the entries in separate tables comprises the use of cross tables containing said ID numbers.

3. The method of claim 2, further comprising the steps of:
c) selecting a desired category of data;
d) orienting one or more of the remaining categories of data to the desired category of data; and
e) generating one or more reports showing said data in a desired format.

4. The method of claim 3, wherein said land rights acquisition project is in connection with an oil and gas drilling project.

5. The method of claim 4, wherein step (c) comprises selecting tracts, and step (d) comprises orienting said contracts table to one or more selected tracts; and step (e) further comprises the steps of
(f) assembling selected contracts related to one or more selected tracts, in a desired sequence;
(g) sequentially page numbering said selected contracts; and
(h) compiling said selected contracts into an abstract.

6. The method of claim 5, comprising the further step of:
(I) creating cover sheets for each of said selected contracts, inserting said cover sheets in advance of said selected contracts, and sequentially numbering the cover sheets within said abstract.

7. A computer-implemented method for entering, storing, and manipulating data related to a land rights acquisition project, comprising the steps of:
a) gathering and entering data into an electronic database, said data stored in a format of:
one or more tables comprising the identity of tracts of land
one or more tables comprising the owners of said tracts of land
one or more tables comprising contracts and other legal instruments related to said tracts of land,
each of said tables comprising one or more entries corresponding to said tracts, owners, and contracts, each of said entries within each of said tables being assigned a unique identification (ID) number;
b) creating one or more cross tables, said cross tables containing said unique ID numbers, and creating an association between at least some of the entries in separate tables, whereby said data may be oriented to any of the variables;
c) selecting a desired category of data;
d) orienting one or more of the remaining categories of data to the desired category of data; and
e) generating one or more reports showing said data in a desired format.

8. The method of claim 7, wherein:
step (c) comprises selecting tracts;
step (d) comprises orienting said one or more contracts tables to one or more selected tracts; and further comprising the steps of
(f) assembling selected contracts related to one or more selected tracts, in a desired sequence;
(g) sequentially page numbering said selected contracts; and
(h) compiling said selected contracts into an abstract.
